(19) United States
(12) Patent Application Publication
(10) Pub. No.: US 2013/0301296 A1
(43) Pub. Date: Nov. 14, 2013

(54) BACKLIGHT UNIT AND LIQUID CRYSTAL DISPLAY DEVICE USING THE SAME

(71) Applicants: Gege Zhou, Shenzhen (CN); Jianfa Huang, Shenzhen (CN)

(72) Inventors: Gege Zhou, Shenzhen (CN); Jianfa Huang, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/811,143

(22) PCT Filed: Jun. 14, 2012
(86) PCT No.: PCT/CN2012/076899

§ 371 Date: Jan. 18, 2013

(30) Foreign Application Priority Data
May 11, 2012 (CN) 201210145290.X

(51) Int. Cl. F21V 8/00

(52) U.S. Cl. CPC G02B 6/0081
USPC 362/611

(57) ABSTRACT

A liquid crystal display device has a liquid crystal panel and a backlight unit, wherein the backlight unit comprises: a light guide plate, having a bottom surface, a light exiting surface opposite to the bottom surface, at least one lateral light incident surface and at least a lateral side, wherein the lateral side includes a retaining surface; a frame body for receiving the light guide plate, having a stopping part disposed at a position corresponding to the retaining surface, wherein the stopping part is closely engaged with the retaining surface of the light guide plate for fixing the light guide plate; and a light source disposed in the frame body, emitting light toward to the lateral light incident surface.

### FIELD OF THE INVENTION

The present invention relates to a backlight unit and a liquid crystal display device using the same, and more particularly to a mechanism in which a frame body is used for fixing a light guide plate (LGP).

### BACKGROUND OF THE INVENTION

A backlight unit is required for liquid crystal display devices. The backlight unit is used as a light source for providing sufficient brightness to display images. The quality of liquid crystal display device is required and the quality of backlight unit is required as well. In the quality requirements, good appearance is basic and very important. Additionally, it is hoped to achieve the goals of light weight, compact size, low power consumption, low cost, high brightness, slim bezel, and so on for the market demand, which are the directions for the backlight units to be improved.

The components of a liquid crystal display device comprise a back plate, a panel, a light guide plate (LGP), light bars, optical films, a plastic frame, a front cover, and so on. The panel, the optical films, the light bars and the LGP are received in a space formed by the back plate, the plastic frame and the front cover, wherein the LGP must be fixed by a frame body to prevent shifting. If the LGP shifts, the uniformity and brightness of the liquid crystal display device may reduce significantly, such that the way for fixing the light guide plate is very important. FIG. 1 shows a conventional fixing way in which an LGP 10 is pressed by a plastic frame 40 and the plastic frame 40 is locked with the back plate 30 by tenons; however, if one applying too much force during locking, the plastic frame 40 may easily deform. In addition, it requires a predetermined tolerance space for convenient assembly, and the light guide plate itself has a thermal expansion and contraction problem, such that a gap must be existed between the plastic frame 40 and the LGP 10. Moreover, when the plastic frame 40 cannot press down the LGP 10, the light reflected from the lateral side of the LGP 10 will emit through the gap between the plastic frame 40 and the LGP 10 to cause a light leakage and light lines in appearance. Further, in prior art, the LGP 10 is mainly fixed in a horizontal direction; therefore, in a vertical direction, because the plastic frame 40 is extended to a light exiting surface of the LGP 10 and the plastic frame 40 is made by a soft material, the LGP 10 may deform easily. Therefore, if the LGP 10 is deformed, the fixing force of the plastic frame for the LGP 10 is reduced. Additionally, because the existing of the plastic frame 40 or the back plate 30 and the plastic frame 40 is extended to the light exiting surface of the LGP 10, it is difficult to reduce the widths of lateral sides of liquid crystal display device to realize a slim bezel.

Therefore, the present invention provides a backlight unit and a liquid crystal display device using the same which comprises a fixing structure for fixing LGP, to prevent a light leakage and realize a slim bezel.

### SUMMARY OF THE INVENTION

One objective of the present invention is to overcome the drawbacks of conventional backlight unit in fixing a light guide plate (LGP). Therefore, the present invention provides a backlight unit having a mechanism in which a frame body is used for fixing the LGP. In the mechanism, a lateral side of the LGP is formed with a retaining surface, and the frame body has a stopping part disposed at a position corresponding to the retaining surface, wherein the stopping part is closely engaged with the retaining surface of the LGP for fixing the LGP. The present invention is intended to solve the problems in the conventional art that: the plastic frame is unable to tightly press down the LGP, so that the light reflected from the lateral side of the LGP passes through the gap between the plastic frame and the LGP, which causes a light leakage, and when the thickness of the frame body is too thick and the frame body is extended to a light exiting surface of the LGP, the slim bezel cannot be realized.

Another objective of the present invention is to overcome the drawbacks of the conventional backlight unit in fixing a light guide plate (LGP). Therefore, the present invention provides a liquid crystal display device having a backlight unit with a mechanism in which a frame body is used for fixing the LGP. In the mechanism, a lateral side of the LGP is formed with a retaining surface, and the frame body has a stopping part disposed at a position corresponding to the retaining surface, wherein the stopping part is closely engaged with the retaining surface of the LGP for fixing the LGP. The present invention is intended to solve the problems in the conventional art that: the plastic frame is unable to tightly press down the LGP, so that the light reflected from the lateral side of the LGP emits through the gap between the plastic frame and the LGP, which causes a light leakage, and when the thickness of the frame body is too thick and the frame body is extended to a light exiting surface of the LGP, the slim bezel cannot be realized.

To solve above-mentioned problems, the present invention provides a backlight unit comprising: a light guide plate having a bottom surface, a light exiting surface opposite to the bottom surface, at least one lateral light incident surface and at least a lateral side, wherein the lateral side includes a retaining surface; a frame body for receiving the light guide plate, having a stopping part disposed at a position corresponding to the retaining surface, wherein the stopping part is closely engaged with the retaining surface of the light guide plate for fixing the light guide plate; and a light source disposed in the frame body, emitting light toward the lateral light incident surface.

In an embodiment of the present invention, the retaining surface comprises a first inclined plane, and the first inclined plane and the bottom surface forms an acute angle. Furthermore, the frame body comprises a back plate and a plastic frame, wherein the back plate includes a bottom plate and a side wall extending upward from around the bottom plate, the plastic frame has a stopping part and a groove coupled with the side wall of the back plate.

In an embodiment of the present invention, the frame body comprises a plastic frame having the stopping part.

In an embodiment of the present invention, the frame body comprises a back plate including a bottom plate and a side wall extending upward from around the bottom plate, and the side wall has the stopping part.

In an embodiment of the present invention, the retaining surface comprises a first inclined plane and a second inclined plane, the first inclined plane and the bottom surface forms an acute angle, and the second inclined plane and the light exiting surface forms an acute angle, the stopping part is closely engaged with the first inclined plane of the retaining surface for fixing the light guide plate. Furthermore, the frame body comprises a back plate including a bottom plate and a side wall extending upward from around the bottom plate, and the side wall has the stopping part.

To solve above-mentioned problems, the present invention provides a liquid crystal display device which has a liquid crystal panel and a backlight unit, wherein the backlight unit comprises a light guide plate, having a bottom surface, a light exiting surface opposite to the bottom surface, at least one lateral light incident surface and at least a lateral side, wherein the lateral side includes a retaining surface; a frame body for receiving the light guide plate, having a stopping part disposed at a position corresponding to the retaining surface, wherein the stopping part is closely engaged with the retaining surface of the light guide plate for fixing the light guide plate; and a light source disposed in the frame body, emitting light toward to the lateral light incident surface.

In an embodiment of above-mentioned liquid crystal display device, the retaining surface comprises a first inclined plane, and the first inclined plane and the bottom surface forms an acute angle. Furthermore, the frame body comprises a back plate and a plastic frame, the back plate includes a bottom plate and a side wall extending upward from around the bottom plate, the plastic frame has a stopping part and a groove coupled with the side wall of the back plate.

In conclusion, the backlight unit and the liquid crystal display device using the same of the present invention has the following advantageous effect: the LGP comprises a retaining surface having an inclined plane. When the frame body applies forces to press down the LGP, one component of force is applied to the LGP in a horizontal direction and another component of force is applied to the LGP in a vertical direction. The horizontal direction is a direction toward the center of LGP, and the vertical direction is a direction pointing down. An upward reaction force is produced when the LGP is deformed, and the upward reaction force will be neutralized with the downward force of frame body, such that the moment of force which forces the frame body to be lifted and the deformation force of the frame body are greatly decreased compared with conventional art; therefore, the deformed LGP can be pressed strongly, the light leakage between the light exiting surface and the frame body is solved, and the light lines are not easily produced so as to improve appearance. Further, the frame body provided by the present invention is unnecessarily extended to the light exiting surface of LGP, in addition, because the width of the frame body can be reduced, a slim bezel can be achieved, but not all of embodiments can reach this effect.

In order to make the aforementioned features and advantages of the present invention more comprehensible, embodiments accompanied with figures are described in detail below.

### BRIEF DESCRIPTION OF THE DRAWINGS

FIG. 1 is a side section view showing a conventional backlight unit.

FIG. 2 is a side section view showing a backlight unit according to a first embodiment of the present invention.

FIG. 3 is a side section view showing a backlight unit according to a second embodiment of the present invention.

FIG. 4 is a side section view showing a backlight unit according to a third embodiment of the present invention.

FIG. 5 is a side section view showing a backlight unit according to a fourth embodiment of the present invention.

### DETAILED DESCRIPTION OF THE INVENTION

The present invention will become more fully understood by reference to the following detailed description thereof when read in conjunction with the attached drawings.

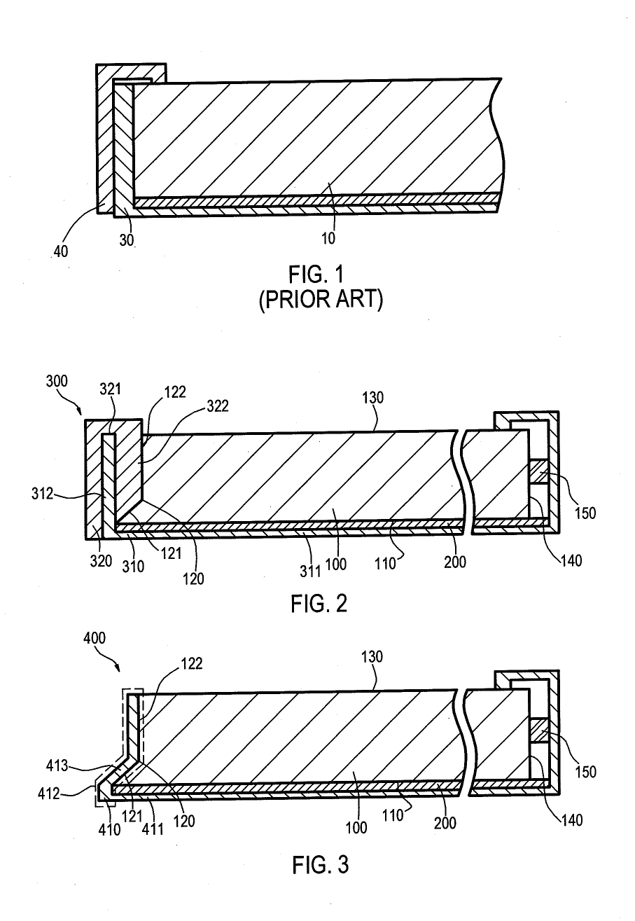

Referring to FIG. 2, it is a side section view showing a backlight unit according to a first embodiment of the present invention. A backlight unit of the first embodiment comprises a light guide plate (LGP) 100 which includes a bottom surface 110, a light exiting surface 130 opposite to the bottom surface 110, at least one lateral light incident surface 140 and at least a lateral side, wherein the lateral side includes a retaining surface 120. The retaining surface 120 comprises an upper part 122 and a lower part 121, wherein the lower part 121 is a first inclined plane and the first inclined plane and the bottom surface 110 forms an acute angle. The upper part 122 perpendicular to the light exiting surface is shrunk inward from the edge of the LGP 100 to the center of the LGP 100. The lower part 121 is connected with the upper part 122; a frame body 300 comprises a back plate 310 and a plastic frame 320, wherein the back plate 310 includes a bottom plate 311 and a side wall 312 extending upward from around the bottom plate 311, the plastic frame 320 has a groove 321 coupled with the side wall 312 of the back plate 310, and a stopping part 322 is disposed between the side wall 312 of the back plate 310 and the retaining surface 120 of the LGP 100, and the stopping part 322 is closely engaged with the retaining surface 120 of the LGP 100 for fixing the LGP 100; a light source 150 which is disposed in the frame body 300 and emits light toward the lateral light incident surface 140.

Furthermore, a reflector 200 is disposed between the bottom plate 311 of the back plate 310 and the LGP 100, and the reflector 200 increases light reflection ratio and avoids light loss.

Referring to FIG. 3, it is a side section view showing a backlight unit according to a second embodiment of the present invention. In the following descriptions, the details of structures and components the same as those of the first embodiment or extremely similar to those of the first embodiment will be omitted except for structures and components different from those of the first embodiment for the purpose of clear and simple explanation.

A frame body 400 of the second embodiment comprises a plastic frame 410 which includes a bottom plate 411 and a side wall 412 extending upward from around the bottom plate 11 (the region circled by dashed line). The side wall comprising a stopping part 413 is closely engaged with the retaining surface 120 of the LGP 100 for fixing the LGP 100.

Furthermore, a reflector 200 is disposed between the bottom plate 411 of the plastic frame 410 and the LGP 100, which increases light reflection ratio and avoids light loss.

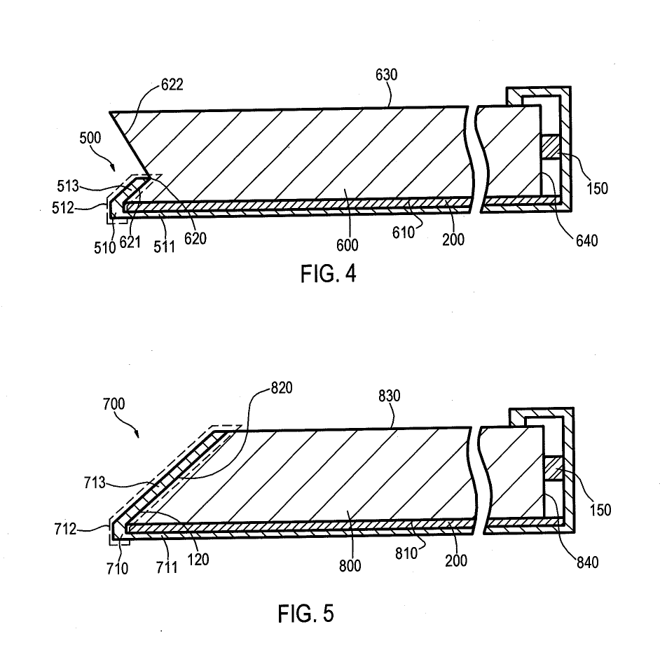

Referring to FIG. 4, it is a side section view showing a backlight unit according to the third embodiment. In the following descriptions, the details of structures and components the same as those of the first and second embodiments or extremely similar to those of the first and second embodiments will be omitted except for structures and components different from those of the first and second embodiments for the purpose of clear and simple explanation.

A backlight unit of the third embodiment comprises a light guide plate (LGP) 600 which includes a bottom surface 610, a light exiting surface 630 opposite to the bottom surface 610, at least one lateral light incident surface 640 and at least a lateral side, wherein the lateral side includes a retaining surface 620. The retaining surface 620 comprises an upper part 622 and a lower part 621, wherein the lower part 621 is a first inclined plane, and the first inclined plane and the bottom surface 610 forms an acute angle. The upper part 622 is a second inclined plane, and the second inclined plane and the light exiting surface 630 form an acute angle. The lower part 621 is connected with the upper part 622. A frame body 500 comprises a back plate 510, wherein the back plate 510 includes a bottom plate 511 and a side wall 512 extending upward from around the bottom plate 511 (the region circled by dashed line). The side wall 512 comprises a stopping part 513 closely engaged with the retaining surface 620 of the LGP 600 for fixing the LGP 600. A light source 150 is disposed in the frame body 500 and emits light toward the lateral light incident surface 640.

Furthermore, a reflector 200 is disposed between the bottom plate 511 of the back plate 510 and the LGP 600, which increases light reflection ratio and avoids light loss.

Referring to FIG. 5, it is a side section view showing a backlight unit according to the fourth embodiment. In the following descriptions, the details of structures and components the same as those of the first, second and third embodiments or extremely similar to those of the first, second and third embodiments will be omitted except for structures and components different from those of the first, second and third embodiments for the purpose of clear and simple explanation.

A backlight unit of the fourth embodiment comprises a light guide plate (LGP) 800 which includes a bottom surface 810, a light exiting surface 830 opposite to the bottom surface 810, at least one lateral light incident surface 840 and at least a lateral side, wherein the lateral side includes a retaining surface 820. The retaining surface 820 is a first inclined plane, and the first inclined plane and the bottom surface 810 forms an acute angle. A frame body 700 comprises a back plate 710, wherein the back plate 710 includes a bottom plate 711 and a side wall 712 extending upward from around the bottom plate 711 (the region circled by dashed line). The side wall 712 comprises a stopping part 713 closely engaged with the retaining surface 820 of the LGP 800 for fixing the LGP 800. A light source 150 is disposed in the frame body 700 and emits light toward the lateral light incident surface 840.

Furthermore, a reflector 200 is disposed between the bottom plate 711 of the back plate 710 and the LGP 800, which increases light reflection ratio and avoids light loss.

A liquid crystal display device has a liquid crystal panel and a backlight unit mentioned in the first embodiment, wherein the backlight unit comprises a light guide plate (LGP) 100 which includes a bottom surface 110, a light exiting surface 130 opposite to the bottom surface 110, at least one lateral light incident surface 140 and at least a lateral side, The lateral side includes a retaining surface 120. The retaining surface 120 comprises an upper part 122 and a lower part 121, wherein the lower part 121 is a first inclined plane, and the first inclined plane and the bottom surface 110 forms an acute angle. The upper part 122 perpendicular to light exiting surface is shrunk inward from the edge of the LGP 100 to the center of the LGP 100. The lower part 121 is connected with the upper part 122. A frame body 300 comprises a back plate 310 and a plastic frame 320, wherein the back plate 310 includes a bottom plate 311 and a side wall 312 extending upward from around the bottom plate 311, the plastic frame 320 has a groove 321 coupled with the side wall 312 of the back plate 310. A stopping part 322 is disposed between the side wall 312 of the back plate 310 and the retaining surface 120 of the LGP 100, and the stopping part 322 is closely engaged with the retaining surface 120 of the LGP 100 for fixing the LGP 100. A light source 150 is disposed in the frame body 300 and emits light toward the lateral light incident surface 140.

Furthermore, a reflector 200 is disposed between the bottom plate 311 of the back plate 310 and the LGP 100, which increases light reflection ratio and avoids light loss.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A backlight unit comprising
a light guide plate, including a bottom surface, a light exiting surface opposite to the bottom surface, at least one lateral light incident surface and at least a lateral side, wherein the lateral side includes a retaining surface, the retaining surface comprises a first inclined plane, and the first inclined plane and the bottom surface forms an acute angle;
a frame body for receiving the light guide plate, having a stopping part disposed at a position corresponding to the retaining surface, wherein the stopping part is closely engaged with the retaining surface of the light guide plate for fixing the light guide plate, the frame body comprises a back plate and a plastic frame, the back plate includes a bottom plate and a side wall extending upward from around the bottom plate, the plastic frame has a stopping part and a groove coupled with the side wall of the back plate; and
a light source disposed in the frame body, emitting light toward the lateral light incident surface.

2. A backlight unit comprising:
a light guide plate, including a bottom surface, a light exiting surface opposite to the bottom surface, at least one lateral light incident surface and at least a lateral side, wherein the lateral side includes a retaining surface;
a frame body for receiving the light guide plate, having a stopping part disposed at a position corresponding to the retaining surface, wherein the stopping part is closely engaged with the retaining surface of the light guide plate for fixing the light guide plate; and
a light source disposed in the frame body, emitting light toward the lateral light incident surface.

3. The backlight unit of claim 2, wherein the retaining surface comprises a first inclined plane, and the first inclined plane and the bottom surface forms an acute angle.

4. The backlight unit of claim 3, wherein the frame body comprises a back plate and a plastic frame, the back plate includes a bottom plate and a side wall extending upward from around the bottom plate, the plastic frame has a stopping part and a groove coupled with the side wall of the back plate.

5. The backlight unit of claim 3, wherein the frame body comprises a plastic frame having the stopping part.

6. The backlight unit of claim 3, wherein the frame body comprises a back plate including a bottom plate and a side wall extending upward from around the bottom plate, and the side wall has the stopping part.

7. The backlight unit of claim 2, wherein the retaining surface comprises a first inclined plane and a second inclined plane, the first inclined plane and the bottom surface forms an acute angle, and the second inclined plane and the light exiting surface forms an acute angle, the stopping part is closely engaged with the first inclined plane of the retaining surface for fixing the light guide plate.

8. The backlight unit of claim 5, wherein the frame body comprises a back plate, the back plate includes a bottom plate and a side wall extending upward from around the bottom plate, the side wall comprises the stopping part.

9. A liquid crystal display device having a liquid crystal panel and a backlight unit, wherein the backlight unit comprises:
a light guide plate, including a bottom surface, a light exiting surface opposite to the bottom surface, at least one lateral light incident surface and at least a lateral side, wherein the lateral side includes a retaining surface;
a frame body for receiving the light guide plate, having a stopping part disposed at a position corresponding to the retaining surface, wherein the stopping part is closely engaged with the retaining surface of the light guide plate for fixing the light guide plate; and
a light source disposed in the frame body, emitting light toward to the lateral light incident surface.

10. The liquid crystal display device of claim 9, wherein the retaining surface comprises a first inclined plane, and the first inclined plane and the bottom surface forms an acute angle.

11. The liquid crystal display device of claim 10, wherein the frame body comprises a back plate and a plastic frame, the back plate includes a bottom plate and a side wall extending upward from around the bottom plate, the plastic frame has a stopping part and a groove coupled with the side wall of the back plate.
